(19) United States
(12) Patent Application Publication
(10) Pub. No.: US 2012/0086658 A1
(43) Pub. Date: Apr. 12, 2012

(54) TABLET COMPUTER WITH OPTION FOR ONE OR TWO SCREENS

(76) Inventor: Payam Moradian, Los Angeles, CA (US)

(21) Appl. No.: 13/269,597

(22) Filed: Oct. 9, 2011

Related U.S. Application Data
(60) Provisional application No. 61/391,551, filed on Oct. 8, 2010.
(60) Provisional application No. 61/392,723, filed on Oct. 13, 2010.

(51) Int. Cl. G09G 5/00; G06F 3/041

(52) U.S. Cl. 345/173

(57) ABSTRACT

Provided is a tablet computer with the option of using one or two screens such as a tablet computer comprising a first and a second touch screen on a respective first and second surface, wherein the second screen is positioned behind the first screen when not in use in a fashion where the front or the back of the second screen is behind the back of the first screen, wherein each screen encompasses at least 50% of the area of the first and second surfaces, wherein the tablet computer can be used with a) the first screen only while the second screen is positioned behind the first screen; b) with both first and second screens in an open position where both screens are visible to a user.

### CROSS-REFERENCE

The present application claims the benefit of U.S. provisional applications 61/391,551 filed on Oct. 8, 2010 and 61/392,723 filed on Oct. 13, 2010, both of which are incorporated by reference in their entirety.

### BACKGROUND SECTION OF THE INVENTION

As the sales of the Apple i-Pad® indicate, tablet computers are becoming more popular with consumers. These tablet computers are composed of a touch sensitive screen and eliminate the keyboard altogether.

A problem with tablet computers is that the screens are relatively small compared to a screen of a traditional computer. A tablet with two screens on the other hand is not that convenient because one screen may be sufficient for a consumer's ordinary needs most of the time.

There is a need in the art for a tablet computer that is as convenient as a single screen tablet computer but allows a consumer the option of having one or two screens.

### SUMMARY OF THE INVENTION

In one embodiment, the present invention provides a tablet computer comprising a first and a second screen on a respective first and second surface, wherein the second screen is positioned behind the first screen when not in use in a fashion where the face or the back of the second screen is behind the back of the first screen, wherein each screen encompasses at least 50% of the area of the first and second surfaces, wherein the tablet computer can be used with a) the first screen only while the second screen is positioned behind the first screen; b) with both first and second screens in an open position where both screens are visible to a user. The tablet computer can comprise a first and a second screen wherein a user can use at least one of the first and second screens independently, wherein the user can detachably connect the first screen to the second screen to obtain a two screen tablet computer in communication with each other. The first and second tablets can be sold separately to detachably be connected to each other. Attaching the first and second screen can be through a joint, with the tablet computer having an open, intermediate and closed position, said closed position obtained when the first screen is upright and the second screen is facing the back of the first screen, the second screen is in down position, said intermediate position obtained where the first and the second screens are moved apart from each as allowed by the joint, said open position obtained after the intermediate position when the first and second screens are moved substantially apart to allow for rotational movement, wherein screen 2 is rotated through the joint to obtain both first and second screen in upright position. The joint can allow movement solely along the Y axis. The second screen can touch the back of the first screen to allow for use as a one screen tablet, and having the second screen slide out to obtain a tablet with two screens. The tablet computer can comprise a case where screen one is attached to the front of the case, and screen 2 is held in position behind screen one, and screen two slides out of the case when needed to obtain a tablet with two screens. Screen one and two can be attached to each other with a joint that forms a Y axis, the joint allowing for folding from an open position to a position where the back of screen 1 touches the back of screen 2, further comprising a cover for screen 2, where the cover in a open position moves to the back of screen 2, and in a closed position moves to protect screen 2. The screen can encompass more than about 70% of the surface per screen. The screen can encompass more than about 80% of the surface per screen. The screen can encompass more than about 90% of the surface per screen. The screen can encompass about 70% to about 90% of the surface per screen. The screen can encompass about 80% to about 90% of the surface per screen. The screen can encompass about 80% to about 95% of the surface per screen. The height of the surface that includes the screen can be about 7 inches to about 12 inches per screen. The height of the surface that includes the screen can be about 8 inches per screen. The height of the surface that includes the screen can be about 9 inches per screen. The height of the surface that includes the screen can be about 10 inches per screen. The height of the surface that includes the screen can be about 11 inches per screen. The height of the surface that includes the screen can be about 12 inches per screen. The height of the surface that includes the screen can be about 9.6 inches per screen. The height of the surface that includes the screen can be about 7.6 inches per screen. The width of the surface that holds the screen can be about 4 to about 9 inches per screen. The width of the surface that holds the screen can be about 4 inches per screen. The width of the surface that holds the screen can be about 5 inches per screen. The width of the surface that holds the screen can be about 6 inches per screen. The width of the surface that holds the screen can be about 7 inches per screen. The width of the surface that holds the screen can be about 8 inches per screen. The width of the surface that holds the screen can be about 9 or 10 or 11 or 12 inches per screen. The width of the surface that holds the screen can be about 7.5 inches per screen. The width of the surface that holds the screen can be about 0.3 to about 0.6 inches per screen. The diagonal size of the screen can be about 6 inches to about 12 inches per screen. The diagonal size of the screen can be about 6, 8, 9, 10, 11, or 12 inches per screen. The tablet computer can have a height of about 7.5 inches, width of about 5.1 inches and a depth of about 0.4 inch per screen. The tablet can have a height of about 9.6 inches, width of about 7.5 inches, and depth of about 0.5 inch per screen. The tablet computer can have a microprocessor that is one GHz or faster. The tablet computer can be capable of carrying out multiple functions. The tablet computer is not primarily dedicated to playing games. The tablet computer can be used as a cell phone. The tablet computer is not preferably capable of being used as a cell phone. The tablet computer can be sized like a smart phone. The tablet can have a length of about 4 to about 5 inches per screen. The tablet can have a width of about 2 to about 3 inches per screen. The tablet can have a depth of about 0.3 inches to about 0.6 inches per screen. The tablet can have a height of about 4.5 to about 5 inches per screen. The tablet can have a width of about 2.3 to about 2.6 inches per screen. The tablet can have a depth of about 0.4 to about 0.5 inches per screen. The tablet can have a diagonal screen size is preferably about 3 to about 5 inches per screen, or about 4 inches per screen. The tablet can have a height of about 5 to about 8 inches per screen. The tablet can have a depth of about 0.3 inches to about 0.6 inches per screen. The tablet can have a width of about 4 to about 7 inches per screen. Surface 1 and surface 2 can have substantially the same areas. The actual area of each screen on the surface 1 and surface 2 is preferably substantially the same. The only function of screen 2 can be to act as an electronic keyboard for screen 1. Screen 2 can have one or more of lower resolution, lower weight, smaller depth, smaller height, smaller area, and smaller width than screen 1, or vice versa. Screen 1 and 2 can be in permanent electronic communication with each other. Screen 1 and 2 can be in temporary electronic communication with each other, allowing for a user to connect and disconnect screen 1 from screen 2 as needed. Both screens can work independently when disconnected. Back of screen 2 or the case can be contoured for the hand. The tablet can have a maximum of five physical buttons on the same surface as the screen per screen. The tablet can have one physical button on the same surface as the screen per screen. The tablet can have no physical buttons on the same surface as the screen per screen. The tablet is not dedicated primarily for playing games. The tablet preferably does not have a physical keyboard. Preferably one or both screens are touch screens. Preferably both screens are touch screens. One screen can be made with a groove to allow the other screen slide into the groove when in an open position so that the distance between both screens is minimized in an open position.

The screens of the tablet computer can have a range of motion in an open position in relation to each other at least from about 180 degrees where the screens are parallel in the same plane to each other to about 90 degrees with the two screens facing each other, wherein the range of motion allows the tablet computer being used with one of the screens as an electronic keyboard for the other screen, and both screens used for reading a book with one page of a book on each screen.

### BRIEF DESCRIPTION OF THE FIGURES

FIG. 1 illustrated an open position where two screens joined to each other through a pivot joint are both upright and facing a user.

FIG. 2 illustrates the intermediate position where one screen is rotated so its back is racing the user.

FIG. 3 illustrates the closed position where one screen is folded away to hide behind the other screen.

FIG. 4 is a side view of the closed position.

FIG. 5 is a side view of the closed position with back of screen 2 contoured for the shape of hand.

FIG. 6 is the bottom view of screen 2 in a case. Screen 1 is not shown.

FIG. 7 is a side view of screen 1 and screen 2 in a case with the opening facing the viewer.

FIG. 8 is a side view of screen 1 on top of screen 2.

FIG. 9 is illustrates the tablet computer of FIG. 8 where it is in an open position by sliding one screen against another screen.

FIG. 10 illustrates screen 1 and 2 joined by a hinge that spans the Y-axis.

FIG. 11 illustrates that closed position of FIG. 10 where screen 2 is moved 180 degrees to hide behind screen 1.

FIG. 12 illustrates a cover that protects screen 2. The cover is shown with phantom lines.

FIG. 13 illustrates a cover connected to top of screen 2 where the cover can be moved from front to back of screen 2.

FIG. 14A illustrated an example of an electronic map of a dual screen tablet where screen 2 is turned on through a switch when the tablet is switched from a single to a dual tablet.

FIG. 14B illustrates an example of an electronic map of two separate tablets that are sold separately and are connected to each other to provide a dual screen tablet.

FIG. 15 illustrates the pivot joint, where the pivot part allows for rotation and the hinge for folding along the Y axis.

FIG. 16 illustrates a ball and socket pivot joint.

### DETAILED DESCRIPTION OF THE INVENTION

The present invention provides for tablet computers having two screens, where one screen is positioned behind or hid behind the first screen, and is used only when the consumer needs more that one screen. The consumer moves the second screen from behind the first screen when needed. The second screen can also be used as an electronic keyboard when needed. Preferably both screens are touch screens. By touch screen it is meant a screen that is responsive to a user's touch.

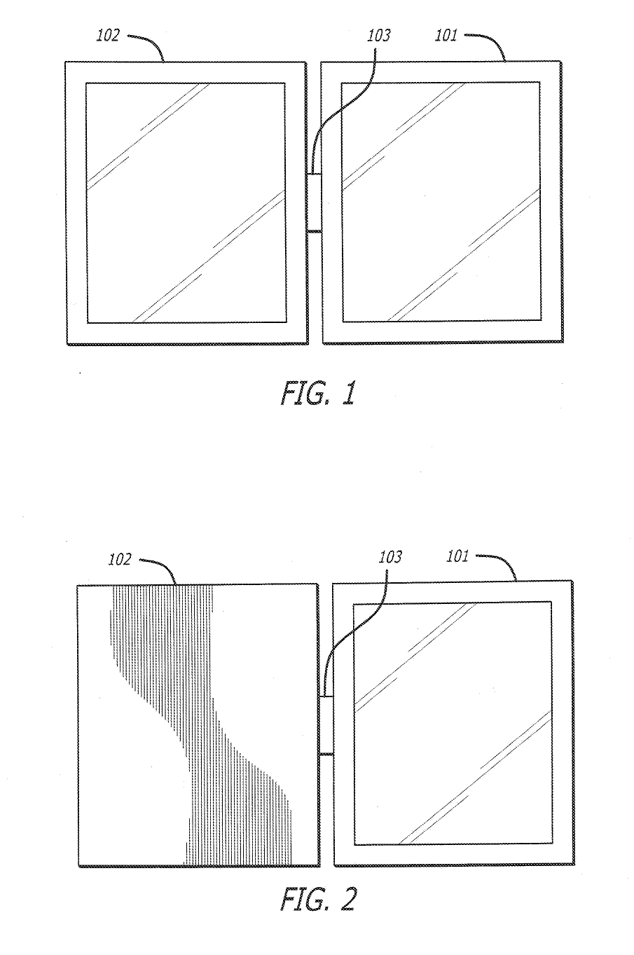

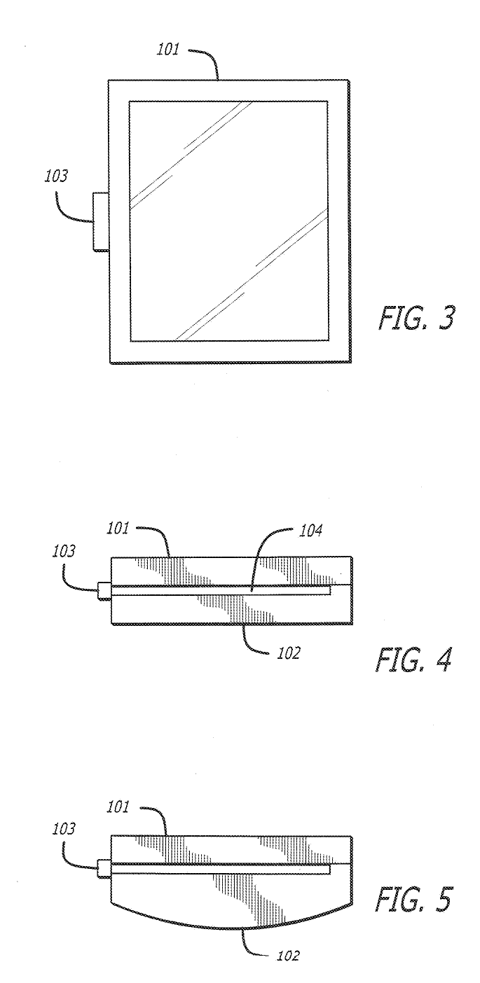

In FIG. 1, the tablet is in an open position. In FIG. 2, the tablet is in an intermediate position where screen 1 (101) and 2 (102) have been rotated 180 degrees. The reason for this rotation is that in closed position, FIG. 3, the back of screen 2 is exposed and screen 2 is protected by back of Screen 1. FIGS. 4 and 5 provide a side view of the closed position. Gap 104 can be designed into the tablet to further protect screen 2.

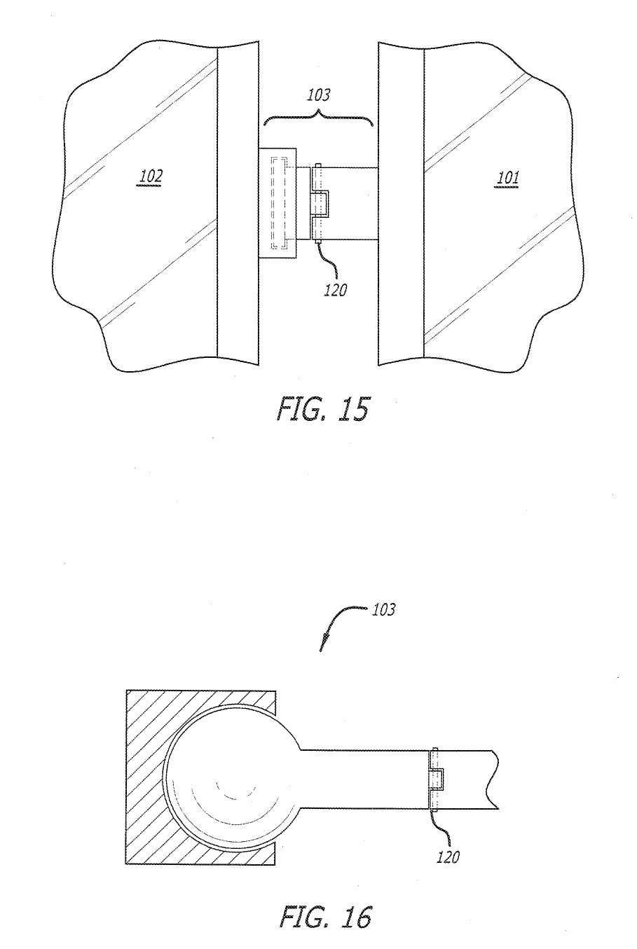

Pivot joint 103 can be used. This joint allows for the 180 degree rotation (up to 3600 to obtain the intermediate position and 180 (up to 360 degrees) folding along the Y axis to move the flipped screen 102 behind screen 101. Electrical communication between screen 101 and 102 can also occur through this joint. FIGS. 15 and 16 provide an example for this joint. In FIG. 15, the side of the joint attached to Screen 2 allows for a full rotation. The hinge allows for folding along the Y axis. FIG. 16 is the same design as FIG. 15 except that a ball and socket joint is used to allow for a greater range of movement. The pivot joint (103) can also have a ball and socket joint if greater movement is desired. The hinge (120) allows for obtaining a 360 degree movement of screens in relation to another. If there is enough friction, the two screens can be stopped anywhere during the motion so as to obtain the position that a user desires. For example, when using one screen as an electronic keyboard, an about 120 degree relationship may be optimal while for reading book an about 160 to about 180 degree relationship may be more optimal.

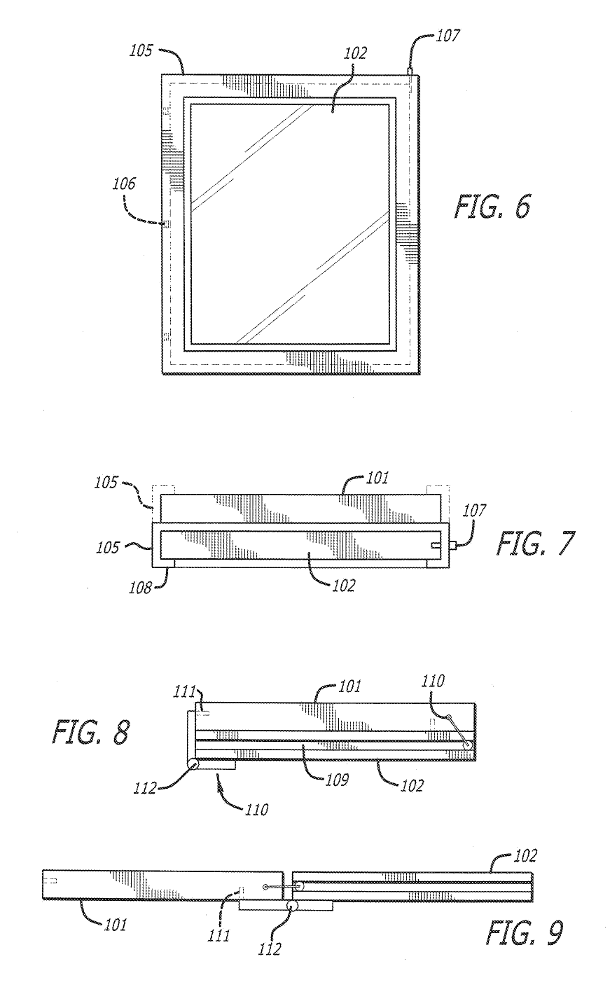

FIGS. 6-9 provide placing screen 101 over screen 102. The two screens can be incorporated in a case to hold them together. FIG. 7 shows the case 105 where screen 1 is places over screen 2. Screen 1 can be permanently attached to the case 105 or be removably attached. Screen 2 moves in and out of Case 105. FIG. 6 shows the position of the lower screen in the case. Latch 107 keeps the screen in place from leaving through the opening of the case. Spring 106 can give a push to the screen when the latch is opened. In this embodiment, the case can permanently hold screen 1 and 2. Alternatively, Screen 1 and 2 can be removed by the consumer and their electronic connection severed when only a single screen is needed. The phantom lines of Case 105 show possibility of bringing the case to cover sides of Screen 1, making such arrangement optimal for a sliding mechanism.

FIG. 8 shows Screen 1 placed in front of screen 2 without use of a case, and screen two slides along tracks (109) to move to the side when needed. One or more arms for sliding (110) can be used.

FIG. 9 shows a connector to secure screen 1 and 2 together after having them slid next to each other. Connector 110 can have a locking mechanism (111) to keep the connector in place and a joint (112) to allow for the connector to be put away when not needed. The connector can also run all along the side of screen one and have screen two slide on the connector, with the sliding automatically lock (snap) the two screens together. There can be two (or more) separate connectors, each close to one end of the screens. There can also be a single connector that also pivots.

In FIG. 8, the connector 110 can have a joint (112) and hold the two screens together. Connector 110 can be eliminated if the sliding mechanism has sufficient friction to keep screen 1 and 2 together. The hinge (112) of connector (110) can also provide a rotation range in the open position (FIG. 9) where screen 1 and 2 can be rotated from 0 to 180 degrees or 90 to 180 degrees. The end of the screens touching each other can be contoured to allow for 180 degree range of movement. The hinge 112 could have sufficient friction to allow the screens remain in a desired angle relative to each other.

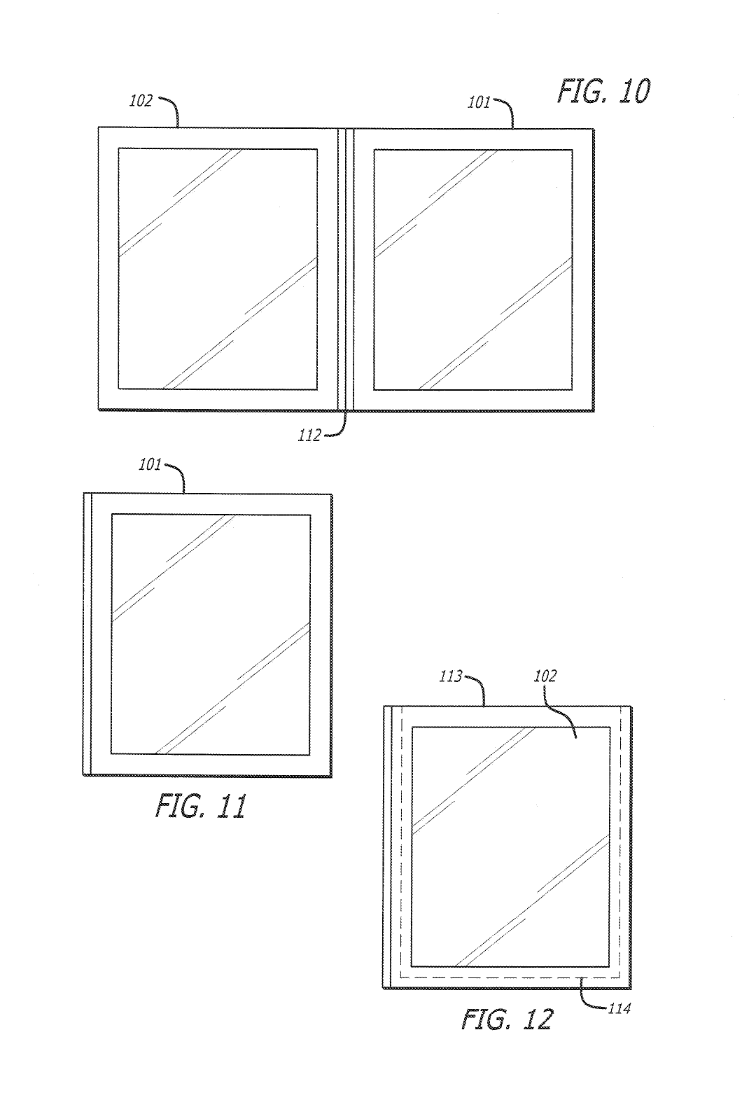

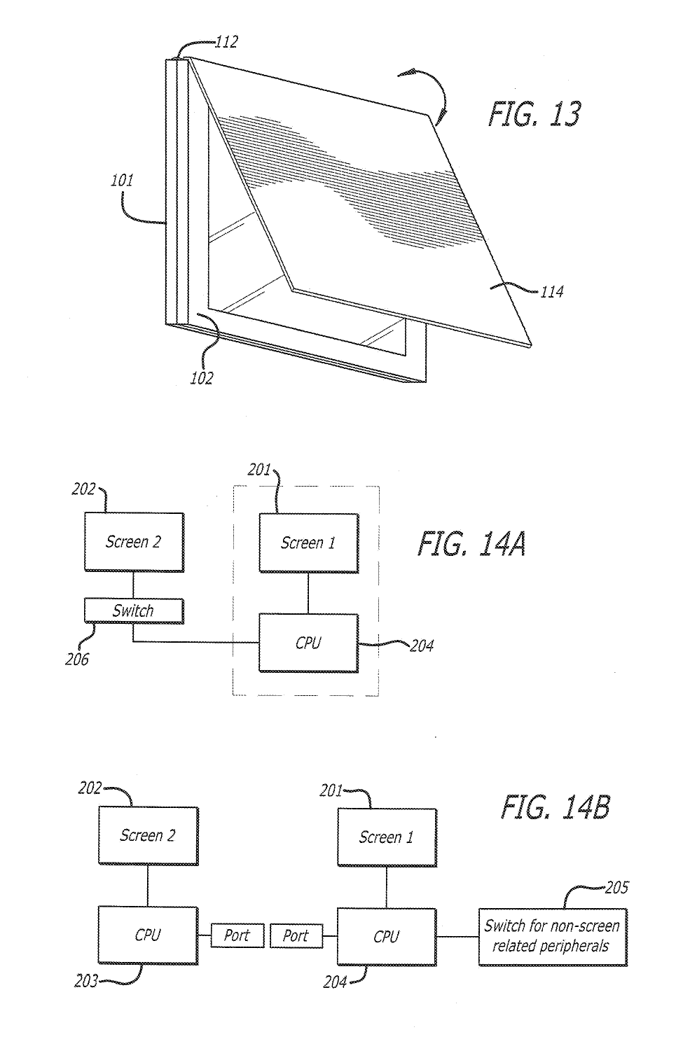

FIG. 10 shows two screens connected by a hinge that opens and closes like a book. The hinge allows for screen 2 to be folded 180 degrees so that the back of screen 2 touches back of screen 1. The hinge can run throughout the two screens or only partially. One or more hinges can be used. A range of motion of 0 degrees to 360 degrees can be obtained. Since in a closed position, screen 2 is exposed and may get damaged, a cover is attached to the top or side of the screen. In a closed position, the cover protects the screen. When the tablet computer is opened, the cover is rotated the back side of Screen 2. FIGS. 12 and 13 show cover protecting screen 2. FIG. 13 shows cover 114 being rotated from front to back but before doing all the way so, screen 1 needs to be rotated away as the cover goes behind screen 2. FIG. 13 shows screen 2 with a cover 114 having two sets of hinges. The first set of hinges can be 0.5 length of the side of the tablet that it attaches to, so to allow a good fit for front and back.

The two screens are in electronic communication with each other. The tablet is preferably designed to work with one screen in a closed position, and turn on the second screen when the second screen is in an open position.

One of the screens can be used as an electronic keyboard in addition to a second screen. The hinges and joints would be made to allow for the proper angle to use one screen as a keyboard. One of the screens can have lower resolution to save on cost and weight. The lower resolution screen would be used as a keyboard or for reading a book or for word processing, versus watching a high definition video. The lower resolution can be 1024×768 for example and a higher resolution can be 1280×720 or higher such as 1366×768 or 1920×1080 (native resolution W×H). The first three can also be used for lower resolution. Or image resolution of 1280×720 can be used for lower resolution and 1920×1080 for higher resolution. As technology improves, the resolutions would be increased respectively. The possible angles of the two screens to each other allowed by the present invention, particularly from 180 degree (two screens parallel to each other) to 90 degrees allows for using one of the screens as a keyboard where an about 120 degree is preferred by an average user or using for a book where closer to 160-180 degrees is preferred by the average user. Preferably the two screens are in the same plane, that is a straight line could pass on top of both screens from one edge to another while touching the screens from one edge (any perimeter point) to another.

The two screens can have a permanent electronic connection to each other. Alternatively, the connection can be temporary (for examples like a USB port mechanism or wireless) where the consumer can use one screen without the hassle of carrying other screen, and then join them together as needed.

FIG. 14A shows an example of an electronic map of a dual screen tablet. A consumer can just use screen 1(201) which is connected to CPU (204). When screen two is brought in an open position by being removed from behind screen one, the switch (206) turns on screen 2 (202) and a dual screen tablet is obtained. The switch (206) can be turned on automatically, for example, by using a magnet to decipher whether the dual screen is in open or closed position.

FIG. 14B illustrates two separate tablet computers that are sold and operated independently that are joined together to obtain a dual screen tablet. This electronic map can also be used with any other embodiment where the tablets can be used separately. The two tablets each having a single screen (201 and 202) are joined together electronically. Ports, such as USB port, can be used to electronically join the tablet computers. Other methods of joining the tablets electronically can be used as well, such as wireless connection. One tablet computer can have a switch (205) to turn off peripherals not related to the screen (functional monitor). These peripherals can include those that connect to a communication network such as WiFi, or applications that are not necessary for having a functional screen (such as word processing applications).

The screen encompasses at least 50% of the surface. Preferably the screen encompasses more than about 70%, more than about 80%, or about 90%. Ranges include about 70% to about 90%, about 80% to about 90%, about 80% to about 95%.

The height of the surface that includes the screen is preferably about 7 inches to about 12 inches. The height can be about 7 inches, about 8 inches, about 9 inches, about 10 inches, about 11 inches or about 12 inches. In one embodiment the height is about 9.6 inches. In another embodiment, the height is about 7.6 inches.

The width is of the surface that holds the screen is preferably about 4 to about 9 inches. The width can be about 4 inches, about 5 inches, about 6 inches, about 7 inches, about 8 inches, about 9 inches or about 10 inches or about 11 inches or about 12 inches. In one embodiment, it is about 7.5 inches.

The height can be longer than the width or vice versa.

The depth of the tablet computer is preferably about 0.3 to about 0.6 inches.

The diagonal size of the screen is preferably about 6 inches to about 12 inches. It can be about 6 inches, about 7 inches, about 8, inches, about 9 inches, about 10 inches, about 11 inches or about 12 inches.

In one embodiment, the tablet computer has a height of about 7.5 inches, width of about 5.1 inches and a depth of about 0.4 inch. In another embodiment, the tablet has a height of about 9.6 inches, width of about 7.5 inches, and depth of about 0.5 inch.

The tablet computer preferably has a microprocessor that is one GHz or faster.

The tablet computer is preferably capable of carrying out multiple functions, including surfing the web, reading books, watching videos, and using applications. The tablet computer is not solely dedicated to playing games. In one embodiment, the tablet computer is not capable of being used as a cell phone.

In another embodiment, the tablet computer is sized like a traditional smartphone and has dimensions that are closer to the i-phone rather than the i-Pad. The height can be about 4 to about 5 inches. The width can be about 2 to about 3 inches. The depth can be about 0.3 inches to about 0.6 inches. The width is that for a single screen. In one embodiment, the height is about 4.5 to about 5 inches, the width is about 2.3 to about 2.6 inches, and the depth is about 0.4 to about 0.5 inches per screen. The diagonal screen size is preferably about 3 to about 5 inches, preferably about 4 inches.

The present invention also allows for a new class of tablet computers, where each screen of the tablet computer is bigger than a smart phone but smaller than the traditional tablet, e.g., the i-Pad. The size of the screens can be such that both of them combined have the same area as the screen of the i-Pad, plus or minus 20%.

The height can be about 5 to about 8 inches. The width can be about inches. The depth can be about 0.3 inches to about 0.6 inches. The width is that for a single screen. The width can be about 4 to about 7 inches.

What is claimed is:

1. A tablet computer comprising a first and a second touch screen on a respective first and second surface, wherein the second screen is positioned behind the first screen when not in use in a fashion where the front or the back of the second screen is behind the back of the first screen, wherein each screen encompasses at least 50% of the area of the first and second surfaces, wherein the tablet computer can be used with a) the first screen only while the second screen is positioned behind the first screen; b) with both first and second screens in an open position where both screens are visible to a user.

2. The tablet computer of claim 1, comprising attaching the first and second screen through a joint, the tablet computer having an open, intermediate and closed position,
the closed position obtained when the first screen is upright and the second screen is facing the back of the first screen, the second screen is in down position, the intermediate position obtained where the first and the second screens are moved apart from each as allowed by the joint,
the open position obtained after the intermediate position when the first and second screens are moved substantially apart to allow for rotational movement, wherein screen 2 is rotated through the joint to obtain both first and second screen in upright position.

3. The tablet computer of claim 1 comprising having the second screen positioned behind the back of the first screen to allow for use as a one screen tablet, and having the second screen slide out to obtain a tablet with two screens.

4. The tablet computer of claim 1 wherein screen one and two are attached to each other with one or more joint that forms a Y axis, the joint allowing for folding from an open position to a position where the back of screen 1 is positioned the back of screen 2, further comprising a cover for screen 2, where the cover in a open position moves to the back of screen 2, and in a closed position moves to protect screen 2.

5. The tablet computer of claim 1, wherein the screen encompasses more than about 70% of the surface per each screen.

6. The tablet computer of claim 1, wherein the actual area of each screen on the surface 1 and surface 2 is substantially the same.

7. The tablet computer of claim 1, wherein the only function of screen 2 is to act as an electronic keyboard for screen 1.

8. The tablet computer of claim 1, wherein the second screen has lower resolution than the first screen.

9. The tablet computer of claim 1, wherein the second screen has smaller area than the first screen.

10. The tablet computer of claim 1, wherein the first screen and the second screen have a range of motion in an open position in relation to each other at least from about 180 degrees where the screens are parallel in the same plane to each other to about 90 degrees with the two screens facing each other, wherein the range of motion allows the tablet computer being used with one of the screens as an electronic keyboard for the other screen, and both screens used for reading a book with one page of a book on each screen.

11. The tablet computer of claim 1, wherein the first screen and the second screen are in temporary electronic communication with each other, allowing for a user to connect and disconnect the first screen from the second screen as needed to obtain two screens that work independently when disconnected.

12. The tablet computer of claim 1, wherein the first and second screens are sold separately to detachably be connected to each other.

13. The tablet computer of claim 1, wherein the tablet has a maximum of five physical buttons on the same surface as the screen per screen.

14. The tablet computer of claim 1, wherein the width of the surface that includes the screen is about 7 inches to about 12 inches per screen.

15. The tablet computer of claim 1, wherein the tablet computer is not capable of being used as a cell phone.

16. The tablet computer of claim 1, wherein the tablet computer is capable of being used as a cell phone.

17. The tablet computer of claim 1, wherein height of the surface that includes the screen is about 7 inches to about 12 inches per screen.

18. A tablet computer comprising a first and a second touch screen wherein a user can use at least one of the first and second screens independently, wherein the user can detachably connect the first screen to the second screen to obtain a two screen tablet computer in communication with each other.

19. The tablet computer of claim 18, wherein the first and second screens are sold separately to be detachably connected to each other.

20. The tablet computer of claim 18, wherein one of the screens has a switch that turns of peripherals not related to use of the screen.
